(19) United States
(12) Patent Application Publication
(10) Pub. No.: US 2018/0042224 A1
(43) Pub. Date: Feb. 15, 2018

(54) IMPROVED SEED LUBRICANT COMPOSITION

(71) Applicant: Syngenta Participations AG, Basel (CH)

(72) Inventors: Ruth Baumgartner, Muenchwilen (CH); Alexander Schaetz, Muenchwilen (CH); Stefan Baum, Muenchwilen (CH); Daniel Husmann, Muenchwilen (CH)

(73) Assignee: Syngenta Participations AG, Basel (CH)

(21) Appl. No.: 15/552,955

(22) PCT Filed: Mar. 10, 2016
(86) PCT No.: PCT/US16/21685

§ 371 Date: Aug. 23, 2017

Related U.S. Application Data
(60) Provisional application No. 62/132,537, filed on Mar. 13, 2015.
(60) Provisional application No. 62/238,220, filed on Oct. 7, 2015.

(51) Int. Cl. A01N 25/08; A01N 25/04

(52) U.S. Cl. CPC A01N 25/08; A01N 25/04

(57) ABSTRACT

The present invention relates to compositions for improving seed flow and reducing dust-exposure levels from pesticide treated seeds by applying the composition described herein.

### FIELD

The present invention relates to compositions for improving seed flow and reducing dust-exposure levels from pesticide treated seeds by applying the composition described herein. Further, the present invention relates to a lubricant composition that includes (a) a suitable solid carrier material, and (b) an oil component.

### BACKGROUND

Treating seeds with pesticidal compositions to protect them against soil-borne, shoot and foliage pests is an established technology on a large variety of crops and often superior to surface treatments as the environmental impact may be diminished when compared to broadcast sprays of pesticidal agents, e.g. no spray-drift. Seed treatments are efficient in protecting crops during germination, emergence and early growth stages and to aid in uniform stand.

Pesticidal seed treatment formulations are often complex mixtures of insecticidal, nematicidal, and fungicidal agents used by different customers, such as farmers, commercial seed producers and seed treatment companies. In order to ensure a safe use of these products, the pesticidal compounds, which are often present in the form of microparticles on the seed surface, must be adhered to the seeds to prevent flaking, abrasion or dust-off during handling or planting.

The present innovation relates to compositions and methods for improving seed flow, plantability and dust exposure from said processes.

### SUMMARY

The present invention is directed, in some embodiments, to a seed lubricant composition that includes a suitable solid carrier material and an oil component.

The present invention is also directed, in some embodiments, to a seed lubricant composition that includes a suitable solid carrier material, an oil component and a surface active compound.

These and other features and advantages of the present invention will become apparent after a review of the following detailed description of the disclosed embodiments and the appended claims.

### BRIEF DESCRIPTION OF THE DRAWINGS

FIG. 1 illustrates the results relating to Seed Dust-off as detailed in Example 10;

FIG. 2 illustrates the results relating to Flowability as detailed in Example 10; and

FIG. 3 illustrates the results relating to a Planter Plate Evaluation as defined in Example 10.

### DESCRIPTION

The compositions of the present invention are directed to seed lubricants, and the uses thereof, that include (a) a solid carrier, and (b) an oil component. As discussed above, the compositions of the present invention may be useful in improving the flowability and plantability of pesticide treated seeds. In addition, the compositions of the present invention may be useful in reducing the dust emission from pesticide treated seeds. As for the methods, the reduction in dust emission may also include respirable dust created by mechanical stress applied to treated seeds at any stage between seed treatment and planting. In addition, the reduction in dust emission may also include respirable dust created by force applied to treated seeds in a mechanical seed planter.

As indicated above, compositions of the present invention include solid carriers. Solid carriers suitable for compositions of the present invention may include inorganic materials of natural or synthetic origin that are insoluble in water such as mineral earths, e.g. magnesium silicate, aluminum silicate, mica, talc, titanium dioxide, pyrophyllite clay, attapulgite clay, ammonium based fertilizers, silicates, kaolins, limestone, dolomite, diatomaceous earth, bentonite, sulfates, carbonates, or oxides of alkaline earth metals (e.g. calcium, magnesium), organic compounds such as carbons and allotropes, ureas, protein- and polysaccharide based powders, e.g. cellulose, starch, and other products of animal or vegetable origin, e.g. lignin, bone meal, tree bark meal, wood meal and nutshell meal, and mixtures thereof. In some embodiments of the invention, the solid carrier is talc, graphite, or mixtures thereof. Further, in embodiments of the invention, the volume based mean particle size of the solid carriers may be between about 1 and about 800 μm. In additional embodiments, the volume based mean particle size may be between about 2 and about 500 μm. In addition, in further embodiments, the volume based mean particle size may be between about 2 and about 100 μm.

The solid carrier component of the present invention may range from 1 to 99% of the total composition based on weight. In some embodiments, the solid carrier components range from 10 to 98% of the total composition based on weight. Still, in further embodiments, the solid carrier components range from about 20 to about 95% of the total composition based on weight. Additionally, the solid carrier component may range from about 30 to about 90% of the total composition based on weight. In further embodiments, the solid carrier component may range from about 50 to 90% of the total composition based on weight, or from about 60 to 90% of the total composition based on weight, or between about 70 to 90% of the total composition based on weight, or between 75 to 90% of the total composition based on weight, or between 80 to 90% of the total composition based on weight.

As further indicated above, the compositions and methods of the present invention include an oil component. In embodiments of the invention, the oil component may be a silicone oil, including any organo-modified polysiloxane, e.g. a polydimethylsiloxane oil. If silicone oil is utilized, it may have a kinematic viscosity between about 0.5 and about 300,000 mm²/s or, in some embodiments, between about 5 and about 200,000 mm²/s or, in further embodiments, between about 10 and about 100,000 mm²/s. The silicone oil may be present in any form, including, but not limited to, as a solid, an aqueous dispersion, an emulsion, as a neat silicon oil, or others. Although the oil component has been described with respect to silicone oil, other oils may also be utilized in the present invention. For example, the oil component may contain mineral oil, vegetable oil, natural or plant oil, or any synthetic oil.

The oil component of the compositions of the present invention may range from about 1 to about 50% of the total composition based on weight. In some embodiments, the oil component ranges from about 5 to about 30% of the total composition based on weight. Still, in further embodiments, the oil components range from about 10 to about 20% of the total composition based on weight. In addition embodiments, the oil components may range from about 15 to about 25% of the total composition based on weight, or between about 15 to about 20% of the total composition based on weight.

The components of the compositions of the present invention may be applied together or separately to treated seed, and they may be applied at any point between the treatment of seeds to the planting of those seeds.

In additional embodiments, the compositions and methods of the invention may also include at least one surface active compound that has an average molecular weight of less than about 10000 Da, less than about 7000 Da, less than about 5000 Da, or between about 200 Da and about 3500 Da. In some embodiments, the surface active compound may enhance the emulsification of the oil component when contacted with water and may also help to improve flowability, dust-off and plantability of pesticide treated seeds.

Surface active compounds that are suitable for the present invention include, but are not limited to, nonionic or ionic emulsifiers and may be selected from aliphatic alcohol alkoxylates, oxo alcohol alkoxylates, aromatic alcohol alkoxylates, oil alkoxylates, fatty alcohol alkoxylates, fatty acid alkoxylates, ethylene oxide and propylene oxide block co-polymers, phosphates, sulfonates, sulfates, metal or ammonium carboxylates, and amides.

Suitable examples of nonionic surface active compounds include, but are not limited to: (a) polyalkoxylated, e.g. polyethoxylated, saturated and unsaturated aliphatic alcohols, having between about 8 to about 24 carbon atoms in the alkyl chain and having about 1 to 100, or about 2 to 50, ethylene oxide units (EO). The free hydroxyl group may be alkoxylated, such as in Genapol X, Genapol OA, Genapol OX, Genapol UD, Genapol LA and Genapol O series (All from Clariant AG from Muttenz, Swithzerland), Crovol M series (from Croda International plc from Snaith, East Riding of Yorkshire, UK) and Lutensol series (From BASF SE from Ludwigshafen, Germany), or subjected to etherification, as in Genapol X 060 (from Clariant AG). (b) polyalkoxylated, e.g. polyethoxylated, hydroxyfatty acids or glycerides which contain hydroxyfatty acids, such as, ricinine or castor oil, having a degree of ethoxylation of between about 10 and about 80, or between about 25 to about 40, such as the Emulsogen EL series (from Clariant AG) or the Agnique CSO series (from BASF SE), and (c) polyalkoxylated, e.g. polyethoxylated, sorbitan esters, such as Atplus 309 F (from Croda International plc) or the Alkamuls series (from Rhodia of La Defense, France).

Suitable examples of ionic surface active compounds include, but are not limited to, Geropon T77 (from Rhodia) (N-methyl-N-oleoyltaurate Na salt); Reax 825 (from Westvaco Corporation of Richmond, Va.) (ethoxylated lignin sulfonate); Stepfac 8171 (from Stepan Company of Northfield, Ill.) (ethoxylated nonylphenol phosphate ester); Ninate 401-A (from Stepan) (calcium alkylbenzene sulfonate); Nansa 1196 (from Huntsman Corporation of The Woodlands, Tex.) (sodium dodecylbenzene sulfonate) Emphos CS-131 (from Witco Corporation of Greenwich, Conn.) (ethoxylated nonylphenol phosphate ester); Atphos 3226 (from Uniquema) (ethoxylated tridecylalcohol phosphate ester).

In the event that such surface active compounds are present, the mass fraction of the surface active compound may be in the range of about 0.1 to about 20% by weight of the total composition, or in the range of about 0.3 to about 10% by weight of the total composition, or in the range of about 0.5 to about 5% by weight of the total composition. In further embodiments, surface active compounds may be present in the range of about 1 to about 5% by weight of the total composition, or between about 1.5 and about 3.5% by weight of the total composition.

The compositions of the present invention, in certain embodiments, may also include additional components, including additional adjuvants, biocides, or other components.

In additional embodiments of the invention, the composition and methods may only consist of the solid carrier and the oil component described above. Further, in additional embodiments, the compositions and methods of the present invention may only consist of the solid carrier, the oil component, and the surface active compound, all as described above.

In further embodiments, the compositions and methods of the present invention may consist essentially of the solid carrier, the oil components and other non-active formularies as described above. In addition, in further embodiments, the compositions and methods of the present invention may consist essentially of the solid carrier, the oil component, the surface active compounds and other non-active formularies, all as described above.

In certain embodiments of the invention, the composition is free of polymers or “stickers”. Such exclusion does not include, however, certain polymers that may be present in seed treatment formulations on seeds to which the compositions of the present invention are applied.

The compositions of the present invention may be useful for applying to pesticide treated seeds with a variety of different pesticidal treatments. For example, the compositions may be useful in connection with seeds treated with insecticides, including thiamethoxam, clothianidin, imidacloprid, and others; fungicides, including fludioxonil, mefenoxam, metalaxyl and others; nematicides, including mectins, and others.

Although certain examples are provided above, the compositions and methods of the present invention may be utilized in connection with seeds treated with any materials. Suitable examples of pesticides that can be treated on seeds for use in the present invention include, but are not limited to:

Insecticides such as abamectin, acephate, acetamiprid, amidoflumet (S-1955), avermectin, azadirachtin, azinphos-methyl, bifenthrin, bifenazate, buprofezin, carbofuran, cartap, chlorantraniliprole (DPX-E2Y45), chlorfenapyr, chlorfluazuron, chlorpyrifos, chlorpyrifos-methyl, chromafenozide, clothianidin, cyflumetofen, cyfluthrin, beta-cyfluthrin, cyhalothrin, lambda-cyhalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, fipronil, flonicamid, flubendiamide, flucythrinate, tau-fluvalinate, flufenerim (UR-50701), flufenoxuron, fonophos, halofenozide, hexaflumuron, hydramethylnon, imidacloprid, indoxacarb, isofenphos, lufenuron, malathion, metaflumizone, metaldehyde, methamidophos, methidathion, methomyl, methoprene, methoxychlor, metofluthrin, monocrotophos, methoxyfenozide, nitenpyram, nithiazine, novaluron, noviflumuron (XDE-007), oxamyl, parathion, parathion-methyl, permethrin, phorate, phosalone, phosmet, phosphamidon, pirimicarb, profenofos, profluthrin, pymetrozine, pyrafluprole, pyrethrin, pyridalyl, pyrifluquinazon, pyriprole, pyriproxyfen, rotenone, ryanodine, spinetoram, spinosad, spirodiclofen, spiromesifen (BSN 2060), spirotetramat, sulprofos, tebufenozide, teflubenzuron, tefluthrin, terbufos, tetrachlorvinphos, thiacloprid, thiamethoxam, thiodicarb, thiosultap-sodium, tralomethrin, triazamate, trichlorfon and triflumuron;

Fungicides such as azoles such as azaconazole, bitertanol, propiconazole, difenoconazole, diniconazole, cyproconazole, epoxiconazole, fluquinconazole, flusilazole, flutriafol, hexaconazole, imazalil, imibenconazole, ipconazole, tebuconazole, tetraconazole, fenbuconazole, metconazole, myclobutanil, perfurazoate, penconazole, bromuconazole, pyrifenox, prochloraz, triadimefon, triadimenol, triflumizole or triticonazole; pyrimidinyl carbinoles such as ancymidol, fenarimol or nuarimol; 2-amino-pyrimidine such as bupirimate, dimethirimol or ethirimol; morpholines such as dodemorph, fenpropidin, fenpropimorph, spiroxamin or tridemorph; anilinopyrimidines such as cyprodinil, pyrimethanil or mepanipyrim; pyrroles such as fenpiclonil or fludioxonil; phenylamides such as benalaxyl, furalaxyl, metalaxyl, R-metalaxyl, ofurace or oxadixyl; benzimidazoles such as benomyl, carbendazim, debacarb, fuberidazole or thiabendazole; dicarboximides such as chlozolinate, dichlozoline, iprodine, myclozoline, procymidone or vinclozolin; carboxamides such as carboxin, fenfuram, flutolanil, mepronil, oxycarboxin or thifluzamide; guanidines such as guazatine, dodine or iminoctadine; strobilurines such as azoxystrobin, kresoxim-methyl, metominostrobin, SSF-129, methyl 2-[(2-trifluoromethyl)-pyrid-6-yloxymethyl]-3-methoxyacrylate or 2-[.alpha.{[(.alpha.-methyl-3-trifluoromethyl-benzyl) imino]-oxy}-o-tolyl]-glyoxylic acid-methylester-O-methyloxime (trifloxystrobin); dithiocarbamates such as ferbam, mancozeb, maneb, metiram, propineb, thiram, zineb or ziram; N-halomethylthio-dicarboximides such as captafol, captan, dichlofluanid, fluoromide, folpet or tolyfluanid; copper compounds such as Bordeaux mixture, copper hydroxide, copper oxychloride, copper sulfate, cuprous oxide, mancopper or oxine-copper; nitrophenol derivatives such as dinocap or nitrothal-isopropyl; organo phosphorous derivatives such as edifenphos, iprobenphos, isoprothiolane, phosdiphen, pyrazophos or toclofos-methyl; and other compounds of diverse structures such as acibenzolar-S-methyl, anilazine, blasticidin-S, chinomethionat, chloroneb, chlorothalonil, cymoxanil, dichlone, diclomezine, dicloran, diethofencarb, dimethomorph, dithianon, etridiazole, famoxadone, fenamidone, fentin, ferimzone, fluazinam, flusulfamide, fenhexamid, fosetyl-aluminium, hymexazol, kasugamycin, methasulfocarb, pencycuron, phthalide, polyoxins, probenazole, propamocarb, pyroquilon, quinoxyfen, quintozene, sulfur, triazoxide, tricyclazole, triforine, validamycin, (S)-5-methyl-2-methylthio-5-phenyl-3-phenyl-amino-3,5-dihydroimidazol-4-o-ne (RPA 407213), 3,5-dichloro-N-(3-chloro-1-ethyl-1-methyl-2-oxopropyl)-4-methylbenzamide (RH 7281), N-allyl-4,5-dimethyl-2-trimethylsilylthiophene-3-carboxamide (MON 65500), 4-chloro-4-cyano-N,N-dimethyl-5-p-tolylimidazole-1-sulfon-amide (IKF-916), N-(1-cyano-1,2-dimethylpropyl)-2-(2,4-dichlorophenoxy)-propionamide (AC 382042), or iprovalicarb (SZX 722);

Bactericides such as streptomycin;

Acaricides such as amitraz, chinomethionat, chlorobenzilate, cyenopyrafen, cyhexatin, dicofol, dienochlor, etoxazole, fenazaquin, fenbutatin oxide, fenpropathrin, fenpyroximate, hexythiazox, propargite, pyridaben and tebufenpyrad; and

Biological agents such as Bacillus thuringiensis, Bacillus thuringiensis delta endotoxin, baculovirus, Pasteuria spp. and entomopathogenic bacteria, virus and fungi.

Any of the above may be included in seed treatment formulations alone or in combination with any number of other active ingredients.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

Preparation of seed treatment compositions

Examples 1-9 relate to the same pesticidal composition consisting of Cruiser®, Maxim® Quattro, and Vibrance® all from Syngenta Crop Protection, LLC of Greensboro, N.C. To this mixture were added color pigments and a customary polymer binder before the slurry was diluted with water and mixed to prepare the seed treatment slurry. The application rates of the seed treatment slurries depend on the corn variety and thousand grain weight (TGW) and are set forth below. The application was conducted in a SATEC application device at 10 kg scale. When flow aids like talc or the compositions of the present innovation were applied to the treated seeds, this was typically conducted by manual agitation of the dry seeds (at least 48 h after treatment) along with the lubricant at a given rate in a drum. The application method of the lubricant is not limited to this procedure.

Measurements

### 1) Flowability

The ability of the lubricant and pesticide treated seeds to flow in bulk was compared to pesticide treated seeds by allowing the seeds to flow through a funnel equipped with a pneumatic closable gate connected with a timer. The gate is opened for 2 seconds, which allows the seeds to flow through the gate, where they are collected and weighed with a balance (typically between 2 and 3 kg). The results are an average of several (typically ten) flowability assessments carried out on dry seeds (2 days after seed treatment) directly after mixing the seeds with the flow aid in a drum (20 manual rotations). The results indicated in the tables for the flowability of the examples are a percentage of the flowability of pesticide treated seeds. A higher percentage indicates a better flowability.

### 2) Plantability

Whereas flowability measurements assess bulk properties of treated seeds as to allow conclusions concerning their behavior during handling and sowing, plantability means a direct measurement of single seeds in terms of planting rate and efficiency in conventional sowing equipment. Efficiency means the absence of planting failures and inaccuracies, such as skips, multiples or seed drops within a range that is inconsistent with the planter's specification. The different sowing devices and parameters are set forth below.

### 3) Dust-Off

The amount of fines that is released by a seed lot is measured in a so called Heubach device. A defined amount of seeds (200 g) is measured within a certain time (5 minutes) by placing the treated seeds in a drum with ridges, which is meant to simulate handling and conveying of the treated seeds when rotating at a speed of 30 rpm. A precision airflow control system provides a constant flow (20 L/min) that carries air-borne particles through a coarse filter separator onto a fiberglass filter disc. The dust quantity is measured by weighing the filter. The data from the ‘dust-off’ measurements is given as average of two distinct seed batches as grams of dust per 100,000 seed kernels.

The data demonstrates that pesticide treated seeds onto which a composition of the present invention was loaded at a rate of at least 5 grams/80,000 seed kernels provide less air-borne particles, i.e. better dust-off, and better flowability and plantability.

### Example 1

10 kg Corn seeds (cv. Falkone, TGW 350) were treated with a slurry comprising 31 g Cruiser 600 FS, 2 g Maxim Quattro, 0.8 g Vibrance, 28 g of a customary polymer sticker and 4 g of the pigment dispersion Color coat red. After dilution with water, the slurry volume accounted for 66 g in the case of cv. Falkone and 87 g in the case of cv. Miko (TGW 267). After drying for 48 hours, the treated seeds were manually mixed in a drum with flow aids at 5, 10, 20, and 40 g/unit (80,000 seeds) rate. The flow aids comprised either talc or a composition of the present invention, i.e. 19% Dow Corning DB 100 polysiloxane and 81% talc.

TABLE 1
The flow relative to pesticide treated seeds was evaluated for different corn
varieties and application rates of talc and improved flow aid, i.e. talc and 19%
polysiloxane DB 100. The improvement achieved with the new flow aid is
expressed in percent versus talc.

| | | Flow aid | | | Improvement |
|---|---|---|---|---|---|
| | | application | Relative flow | | in relative |
| | Corn | rate (g/80′000 | (%); Talc + | Relative flow | flow versus |
| sample | variety/TGW | seeds) | polysiloxane | (%); Talc | talc |
| 1 | Falkone/350 | 5 | 106 | 105 | 1% |
| 2 | Falkone/350 | 10 | 108 | 103 | 5% |
| 3 | Falkone/350 | 20 | 106 | 105 | 1% |
| 4 | Falkone/350 | 40 | 105 | 104 | 1% |
| 5 | Miko/267 | 5 | 112 | 108 | 4% |
| 6 | Miko/267 | 10 | 111 | 108 | 3% |
| 7 | Miko/267 | 20 | 108 | 107 | 1% |
| 8 | Miko/267 | 40 | 105 | 104 | 1% |

TABLE 2
The total grams of dust per 100,000 kernels were evaluated for different corn
varieties and application rates of talc and an embodiment of the present invention,
i.e. talc and 19% polysiloxane DB 100. The improvement achieved with the new
flow aid is expressed in percent versus talc. All data relate to the average of two seed
batches measured in a 5 min Heubach test with 200 grams of treated seeds.

| | | Flow aid | | | |
|---|---|---|---|---|---|
| | | application | Dust/100′000 | | Decrease |
| | Corn | rate (g/80′000 | seeds (g); Talc + | Dust/100′000 | in dust |
| sample | variety/TGW | seeds) | polysiloxane | seeds (g); Talc | versus talc |
| 1 | Falkone/350 | 5 | 0.67 | 0.78 | 14% |
| 2 | Falkone/350 | 10 | 0.64 | 0.95 | 33% |
| 3 | Falkone/350 | 20 | 0.51 | 1.67 | 69% |
| 4 | Falkone/350 | 40 | 0.36 | 3.51 | 90% |
| 5 | Miko/267 | 5 | 0.19 | 0.18 | — |
| 6 | Miko/267 | 10 | 0.17 | 0.44 | 61% |
| 7 | Miko/267 | 20 | 0.17 | 1.04 | 84% |
| 8 | Miko/267 | 40 | 0.14 | 2.74 | 95% |

TABLE 3
The planting rate of treated seeds in percent was evaluated in a John Deere
finger pick-up planter for different corn varieties and application rates of
talc and an embodiment of the present invention, i.e. talc and 19%
polysiloxane DB 100. The planting rate of pesticide treated seeds without
flow aid was 94% for cv. Falkone and 93% for cv. Miko, which is the
relevant reference.

| | | Flow aid | | |
|---|---|---|---|---|
| | | application | Planting rate | |
| | Corn | rate (g/80′000 | (%); Talc + | Planting rate |
| sample | variety/TGW | seeds) | polysiloxane | (%); Talc |
| 1 | Falkone/350 | 5 | 95 | 99 |
| 2 | Falkone/350 | 10 | 95 | 95 |
| 3 | Falkone/350 | 20 | 94 | 95 |
| 4 | Falkone/350 | 40 | 92 | 94 |
| 5 | Miko/267 | 5 | 94 | 92 |
| 6 | Miko/267 | 10 | 94 | 94 |
| 7 | Miko/267 | 20 | 93 | 94 |
| 8 | Miko/267 | 40 | 91 | 92 |

### Example 2

Example 2 sets forth the results from experiment 1 comparing the influence of different polysiloxane levels, i.e. 5, 10, and 15% polysiloxane DB 100, in embodiments of the present invention on the plantability and dust levels.

TABLE 4
The total grams of dust per 100,000 kernels and the planting rate
(in percent), % Population of single seeds in inter quartile range
(Q25-Q75, the desired spacing according to planter specification),
% Skips (percentage of seeds planted outside of the specified
range) and % Multiples (percentage of more than one planted seed)
after 40 min of operation is depicted (Monosem vacuum planter).
The application rate of the flow aid was 10 g/unit on cv. Falkone.

| | | Dust/ | | | | |
|---|---|---|---|---|---|---|
| | Polysiloxane | 100′000 | | Population | | |
| | content in | seeds | Planting | in IQR | Skips | Multiples |
| sample | flow aid (%) | (g) | rate (%) | (%) | (%) | (%) |
| 1 | 5 | 2.08 | 96 | 93 | 6 | 1 |
| 2 | 10 | 1.7 | 95 | 92 | 6 | 2 |
| 3 | 15 | 1.04 | 95 | 92 | 6 | 2 |

### Example 3

Examples 3-5 set forth the results from experiments 1-2 by comparing the influence of different polysiloxane levels, i.e. 5 and 15% Dow Corning DB 100, and emulsifier concentrations, i.e. 2.5 and 5% Nansa 1169, in embodiments of the present invention on the plantability and dust levels. In example 4 the flow aid contains a mixture of talc with 15% Dow Corning DB 100 and 2.5% Nansa 1169, which was evaluated on cv. Falkone at different application rates, i.e. 5, 10, 20, and 40 g per 80,000 kernels.

TABLE 5
The total grams of dust per 100,000 kernels and the planting rate
(in percent), % Population of single seeds in inter quartile range,
% Skips and % Multiples after 40 min of operation is depicted
(Monosem vacuum planter). The embodiment of the present
invention used includes 15% polysiloxane DB 100 and
2.5% emulsifier on a talc carrier.

| | | Dust/ | | | | |
|---|---|---|---|---|---|---|
| | Flow aid | 100′000 | | Population | | |
| | application | seeds | Planting | in IQR | Skips | Multiples |
| sample | rate (g/unit) | (g) | rate (%) | (%) | (%) | (%) |
| 1 | 5 | 1.29 | 90 | 86 | 12 | 2 |
| 2 | 10 | 1.24 | 91 | 86 | 12 | 2 |
| 3 | 20 | 1.27 | 91 | 92 | 6 | 2 |
| 4 | 40 | 1.48 | 93 | 90 | 8 | 2 |

Example 4

In Example 4 an embodiment of the present invention contains a mixture of talc with 5% Dow Corning DB 100 and 2.5% Nansa 1169, which was evaluated on cv. Falkone at different application rates, i.e. 5, 10, 20, and 40 g per 80,000 kernels.

TABLE 6
The total grams of dust per 100,000 kernels and the planting rate
(in percent), % Population of single seeds in inter quartile range,
% Skips and % Multiples after 40 min of operation is depicted
(Monosem vacuum planter). The embodiment of the present
invention contains 5% polysiloxane DB 100 and 2.5%
emulsifier on a talc carrier.

| | | Dust/ | | | | |
|---|---|---|---|---|---|---|
| | Flow aid | 100′000 | | Population | | |
| | application | seeds | Planting | in IQR | Skips | Multiples |
| sample | rate (g/unit) | (g) | rate (%) | (%) | (%) | (%) |
| 1 | 5 | 1.75 | 90 | 86 | 12 | 2 |
| 2 | 10 | 2.3 | 92 | 88 | 10 | 2 |
| 3 | 20 | 3.72 | 91 | 86 | 12 | 2 |
| 4 | 40 | 5.15 | 91 | 87 | 11 | 2 |

Example 5

In Example 5 an embodiment of the present invention includes a mixture of talc with 15% Dow Corning DB 100 and 5% Nansa 1169, which was evaluated on cv. Falkone at different application rates, i.e. 5, 10, 20, and 40 g per 80,000 kernels.

TABLE 7
The total grams of dust per 100,000 kernels and the planting rate
(in percent), % Population of single seeds in inter quartile range,
% Skips and % Multiples after 40 min of operation is depicted
(Monosem vaccum planter). An embodiment of the present
invention contains 15% polysiloxane DB 100 and
5% emulsifier on a talc carrier.

| | | Dust/ | | | | |
|---|---|---|---|---|---|---|
| | Flow aid | 100′000 | | Population | | |
| | application | seeds | Planting | in IQR | Skips | Multiples |
| sample | rate (g/unit) | (g) | rate (%) | (%) | (%) | (%) |
| 1 | 5 | 1.33 | 93 | 89 | 9 | 2 |
| 2 | 10 | 1.32 | 91 | 87 | 11 | 2 |
| 3 | 20 | 1.56 | 91 | 87 | 11 | 2 |
| 4 | 40 | 1.44 | 92 | 88 | 10 | 2 |

Example 6

In Example 6 an embodiment of the present invention includes a mixture of talc with 17.5% Wacker AK 350, which was evaluated on corn varieties Falkone, Miko, Etono, and hybrid cv. N63R3000GT and N12RGT at different application rates, i.e. 5, 10, 20 g per 80,000 kernels. In addition, talc was also applied at a recommended commercial rate, i.e. 70 g per 80,000 kernels.

TABLE 8
The relative flow and total grams of dust per 100,000 seeds are depicted
with respect to batches of pesticide treated corn varieties and treated
seeds mixed with flow aid, i.e. 17.5% Wacker AK 350 on a talc carrier,
at different application rates. The values obtained with commercial talc
are depicted in brackets in the respective columns.

| | | Flow aid | | |
|---|---|---|---|---|
| | | application | Dust/100′000 | Relative flow |
| sample | Corn variety | rate (g/unit) | seeds (g) | (%) |
| 1 | Falkone | 0 | 1.67 | 100 |
| 2 | Falkone/ | 5 | 1.97 | 103 |
| 3 | Falkone | 10 | 1.84 | 103 |
| 4 | Falkone | 20 | 1.72 | 100 |
| 5 | Miko | 0 | 0.98 | 100 |
| 6 | Miko | 5 | 0.38 | 106 |
| 7 | Miko | 10 | 0.55 | 104 |
| 8 | Miko | 20 | 0.59 | 104 |
| 9 | Etono | 0 | 1.31 | 100 |
| 10 | Etono | 5 | 1.39 | 104 |
| 11 | Etono | 10 | 1.36 | 103 |
| 12 | Etono | 20 | 1.97 | 105 |
| 13 | N63R3000GT | 0 | 0.17 | 100 |
| 14 | N63R3000GT | 5 | 0.26 (0.32) | 112 (112) |
| 15 | N63R3000GT | 10 | 0.31 (0.59) | 111 (113) |
| 16 | N63R3000GT | 20 | 0.32 (1.37) | 109 (111) |
| 17 | N63R3000GT | 70 | (6.93) | (105) |
| 18 | N12RGT | 0 | 0.24 | 100 |
| 19 | N12RGT | 5 | 0.23 (0.36) | 111 (111) |
| 20 | N12RGT | 10 | 0.22 (0.41) | 115 (111) |
| 20 | N12RGT | 20 | 0.17 (1.23) | 110 (108) |
| 22 | N12RGT | 70 | (6.51) | (105) |

TABLE 9
The planting rate (in percent), % Population of single seeds in
inter quartile range, % Singulation, % Skips and % Multiples
after 40 min of operation in a Monosem seed planter
is depicted for cv. Falkone, Miko, and Etono.

| | | Flow aid | | Population | | |
|---|---|---|---|---|---|---|
| | Corn | application | Planting | in IQR | Skips | Multiples |
| sample | variety | rate (g/unit) | rate (%) | (%) | (%) | (%) |
| 1 | Falkone | 0 | 90 | 85 | 13 | 2 |
| 2 | Falkone | 5 | 94 | 90 | 8 | 2 |
| 3 | Falkone | 10 | 92 | 88 | 10 | 2 |
| 4 | Falkone | 20 | 90 | 85 | 13 | 2 |
| 5 | Miko | 0 | 99 | 96 | 2 | 2 |
| 6 | Miko | 5 | 99 | 96 | 3 | 1 |
| 7 | Miko | 10 | 99 | 96 | 3 | 1 |
| 8 | Miko | 20 | 98 | 96 | 3 | 1 |
| 9 | Etono | 0 | 96 | 94 | 5 | 1 |
| 10 | Etono | 5 | 97 | 95 | 4 | 1 |
| 11 | Etono | 10 | 95 | 96 | 6 | 1 |
| 12 | Etono | 20 | 92 | 90 | 9 | 1 |

Example 7

In Example 7 an embodiment of the present invention including a mixture of talc with 17.5% Wacker AK 350 and 1.75% Genapol X-060, which was evaluated on corn varieties Falkone, Miko, Etono, and hybrid cv. N63R3000GT and N12RGT at different application rates, i.e. 5, 10, 20 g per 80,000 kernels. In addition, talc was also applied at a recommended commercial rate, i.e. 70 g per 80,000 kernels.

TABLE 10
The relative flow and total grams of dust per 100,000 seeds are depicted
with respect to batches of pesticide treated corn varieties and treated
seeds mixed with flow aid, i.e. 17.5% Wacker AK 350 and 1.75%
Genapol X-060 on a talc carrier, at different application rates. The values
obtained with commercial talc are depicted in parentheses in the
respective columns.

| | | Flow aid | | |
|---|---|---|---|---|
| | | application | Dust/100′000 | Relative flow |
| sample | Corn variety | rate (g/unit) | seeds (g) | (%) |
| 1 | Falkone | 0 | 1.67 | 100 |
| 2 | Falkone | 5 | 1.77 | 102 |
| 3 | Falkone | 10 | 2.67 | 102 |
| 4 | Falkone | 20 | 2.01 | 101 |
| 5 | Miko | 0 | 0.98 | 100 |
| 6 | Miko | 5 | 0.55 | 107 |
| 7 | Miko | 10 | 0.51 | 105 |
| 8 | Miko | 20 | 0.41 | 102 |
| 9 | Etono | 0 | 1.31 | 100 |
| 10 | Etono | 5 | 0.85 | 108 |
| 11 | Etono | 10 | 0.88 | 107 |
| 12 | Etono | 20 | 0.79 | 106 |
| 13 | N63R3000GT | 0 | 0.17 | 100 |
| 14 | N63R3000GT | 5 | 0.28 (0.32) | 108 (112) |
| 15 | N63R3000GT | 10 | 0.30 (0.59) | 110 (113) |
| 16 | N63R3000GT | 20 | 0.24 (1.37) | 109 (111) |
| 17 | N63R3000GT | 70 | (6.93) | (105) |
| 18 | N12RGT | 0 | 0.24 | 100 |
| 19 | N12RGT | 5 | 0.21 (0.36) | 110 (111) |
| 20 | N12RGT | 10 | 0.18 (0.41) | 108 (111) |
| 21 | N12RGT | 20 | 0.16 (1.23) | 109 (108) |
| 22 | N12RGT | 70 | (6.51) | (105) |

TABLE 11
The planting rate (in percent), % Population of single seeds in
inter quartile range, % Skips and % Multiples after 40 min of
operation in a Monosem seed planter is depicted for
cv. Falkone, Miko, and Etono.

| | | Flow aid | | Population | | |
|---|---|---|---|---|---|---|
| | Corn | application | Planting | in IQR | Skips | Multiples |
| sample | variety | rate (g/unit) | rate (%) | (%) | (%) | (%) |
| 1 | Falkone | 0 | 90 | 85 | 13 | 2 |
| 2 | Falkone | 5 | 94 | 90 | 8 | 2 |
| 3 | Falkone | 10 | 92 | 88 | 10 | 2 |
| 4 | Falkone | 20 | 90 | 85 | 13 | 2 |
| 5 | Miko | 0 | 99 | 96 | 2 | 2 |
| 6 | Miko | 5 | 99 | 96 | 3 | 1 |
| 7 | Miko | 10 | 99 | 96 | 3 | 1 |
| 8 | Miko | 20 | 98 | 96 | 3 | 1 |
| 9 | Etono | 0 | 96 | 94 | 5 | 1 |
| 10 | Etono | 5 | 97 | 95 | 4 | 1 |
| 11 | Etono | 10 | 95 | 96 | 6 | 1 |
| 12 | Etono | 20 | 92 | 90 | 9 | 1 |

Example 8

In Example 8 an embodiment of the present invention includes a mixture of talc with 17.5% Wacker AK 12500, which was evaluated on corn varieties Falkone, Miko, Etono, and hybrid cv. N63R3000GT and N12RGT at different application rates, i.e. 5, 10, 20 g per 80,000 kernels. In addition, talc was also applied at a recommended commercial rate, i.e. 70 g per 80,000 kernels.

TABLE 12
The relative flow and total grams of dust per 100,000 seeds are depicted
with respect to batches of pesticide treated corn varieties and treated
seeds mixed with flow aid, i.e. 17.5% Wacker AK 12500 on a talc carrier,
at different application rates. The values obtained with commercial talc
are depicted in parentheses in the respective columns.

| | | Flow aid | | |
|---|---|---|---|---|
| | | application | Dust/100′000 | Relative flow |
| sample | Corn variety | rate (g/unit) | seeds (g) | (%) |
| 1 | Falkone | 0 | 1.67 | 100 |
| 2 | Falkone | 5 | 1.7 | 103 |
| 3 | Falkone | 10 | 1.63 | 102 |
| 4 | Falkone | 20 | 1.96 | 101 |
| 5 | Miko | 0 | 0.98 | 100 |
| 6 | Miko | 5 | 0.52 | 105 |
| 7 | Miko | 10 | 0.46 | 104 |
| 8 | Miko | 20 | 0.42 | 105 |
| 9 | Etono | 0 | 1.31 | 100 |
| 10 | Etono | 5 | 0.63 | 107 |
| 11 | Etono | 10 | 0.74 | 108 |
| 12 | Etono | 20 | 0.92 | 107 |
| 13 | N63R3000GT | 0 | 0.17 | 100 |
| 14 | N63R3000GT | 5 | 0.23 (0.32) | 110 (112) |
| 15 | N63R3000GT | 10 | 0.20 (0.59) | 110 (113) |
| 16 | N63R3000GT | 20 | 0.15 (1.37) | 110 (111) |
| 17 | N63R3000GT | 70 | (6.93) | (105) |
| 18 | N12RGT | 0 | 0.24 | 100 |
| 19 | N12RGT | 5 | 0.26 (0.36) | 110 (111) |
| 20 | N12RGT | 10 | 0.22 (0.41) | 109 (111) |
| 21 | N12RGT | 20 | 0.15 (1.23) | 110 (108) |
| 22 | N12RGT | 70 | (6.51) | (105) |

TABLE 13
The planting rate (in percent), % Population of single seeds in
inter quartile range, % Skips and % Multiples after 40 min of
operation in a Monosem seed planter is depicted
for cv. Falkone, Miko, and Etono.

| | | Flow aid | | Population | | |
|---|---|---|---|---|---|---|
| | Corn | application | Planting | in IQR | Skips | Multiples |
| sample | variety | rate (g/unit) | rate (%) | (%) | (%) | (%) |
| 1 | Falkone | 0 | 90 | 85 | 13 | 2 |
| 2 | Falkone | 5 | 93 | 89 | 9 | 2 |
| 3 | Falkone | 10 | 94 | 91 | 8 | 1 |
| 4 | Falkone | 20 | 94 | 90 | 8 | 2 |
| 5 | Miko | 0 | 99 | 96 | 2 | 2 |
| 6 | Miko | 5 | 99 | 97 | 2 | 1 |
| 7 | Miko | 10 | 99 | 96 | 3 | 1 |
| 8 | Miko | 20 | 99 | 96 | 3 | 1 |
| 9 | Etono | 0 | 96 | 94 | 5 | 1 |
| 10 | Etono | 5 | 96 | 94 | 5 | 1 |
| 11 | Etono | 10 | 96 | 93 | 6 | 1 |
| 12 | Etono | 20 | 93 | 90 | 9 | 1 |

Example 9

In Example 9 an embodiment of the present invention includes a mixture of talc with 17.5% Wacker AK 12500 and 1.75% Genapol X-060, which was evaluated on corn varieties Falkone, Miko, Etono, and hybrid cv. N63R3000GT and N12RGT at different application rates, i.e. 5, 10, 20 g per 80,000 kernels. . In addition, talc was also applied at a recommended commercial rate, i.e. 70 g per 80,000 kernels.

TABLE 14
The relative flow and total grams of dust per 100,000 seeds are depicted
with respect to batches of pesticide treated corn varieties and treated
seeds mixed with flow aid, i.e. 17.5% Wacker AK 12500 and 1.75%
Genapol X-060 on a talc carrier, at different application rates. The
values obtained with commercial talc are depicted in brackets in the
respective columns.

| | | Flow aid | | |
|---|---|---|---|---|
| | | application | Dust/100′000 | Relative flow |
| sample | Corn variety | rate (g/unit) | seeds (g) | (%) |
| 1 | Falkone | 0 | 1.67 | 100 |
| 2 | Falkone | 5 | 1.64 | 102 |
| 3 | Falkone | 10 | 1.87 | 102 |
| 4 | Falkone | 20 | 2.09 | 100 |
| 5 | Miko | 0 | 0.98 | 100 |
| 6 | Miko | 5 | 0.45 | 106 |
| 7 | Miko | 10 | 0.41 | 106 |
| 8 | Miko | 20 | 0.39 | 103 |
| 9 | Etono | 0 | 1.31 | 100 |
| 10 | Etono | 5 | 0.76 | 108 |
| 11 | Etono | 10 | 0.67 | 108 |
| 12 | Etono | 20 | 1.21 | 105 |
| 13 | N63R3000GT | 0 | 0.17 | 100 |
| 14 | N63R3000GT | 5 | 0.15 (0.32) | 110 (112) |
| 15 | N63R3000GT | 10 | 0.15 (0.59) | 109 (113) |
| 16 | N63R3000GT | 20 | 0.15 (1.37) | 110 (111) |
| 17 | N63R3000GT | 70 | (6.93) | (105) |
| 18 | N12RGT | 0 | 0.24 | 100 |
| 19 | N12RGT | 5 | 0.14 (0.36) | 110 (111) |
| 20 | N12RGT | 10 | 0.11 (0.41) | 109 (111) |
| 21 | N12RGT | 20 | 0.13 (1.23) | 110 (108) |
| 22 | N12RGT | 70 | (6.51) | (105) |

TABLE 15
The planting rate (in percent), % Population of single seeds in
inter quartile range, % Singulation, % Skips and % Multiples
after 40 min of operation in a Monosem seed planter is
depicted for cv. Falkone, Miko, and Etono.

| | | Flow aid | | Population | | |
|---|---|---|---|---|---|---|
| | Corn | application | Planting | in IQR | Skips | Multiples |
| sample | variety | rate (g/unit) | rate (%) | (%) | (%) | (%) |
| 1 | Falkone | 0 | 90 | 85 | 13 | 2 |
| 2 | Falkone | 5 | 93 | 90 | 8 | 2 |
| 3 | Falkone | 10 | 92 | 88 | 10 | 2 |
| 4 | Falkone | 20 | 86 | 80 | 18 | 2 |
| 5 | Miko | 0 | 99 | 96 | 2 | 2 |
| 6 | Miko | 5 | 99 | 97 | 2 | 1 |
| 7 | Miko | 10 | 99 | 96 | 3 | 1 |
| 8 | Miko | 20 | 99 | 96 | 3 | 1 |
| 9 | Etono | 0 | 96 | 94 | 5 | 1 |
| 10 | Etono | 5 | 96 | 94 | 5 | 1 |
| 11 | Etono | 10 | 95 | 93 | 6 | 1 |
| 12 | Etono | 20 | 89 | 85 | 14 | 1 |

Example 10

In Example 10, various embodiments of the present invention were tested against other commercially-available flow aids. The flow aids were all utilized on corn seeds that included standard fungicide and insecticide pesticide seed treatments. In particular, Cruiser Maxx Corn 500 was utilized for each pesticide seed treatment.

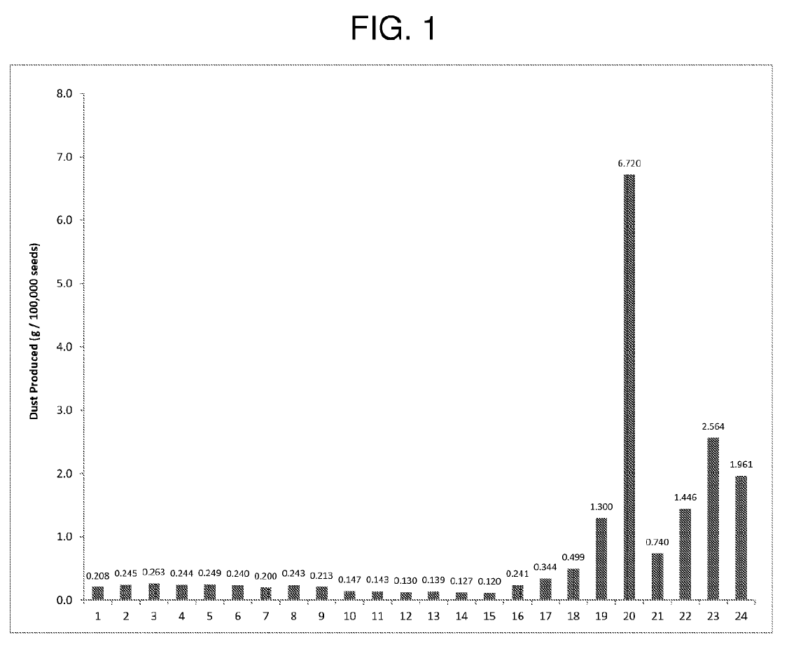

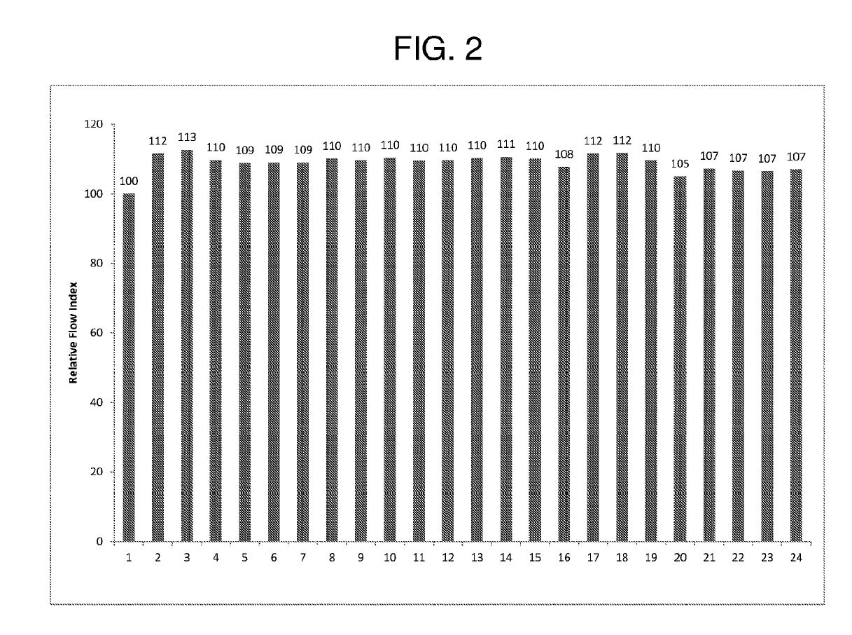

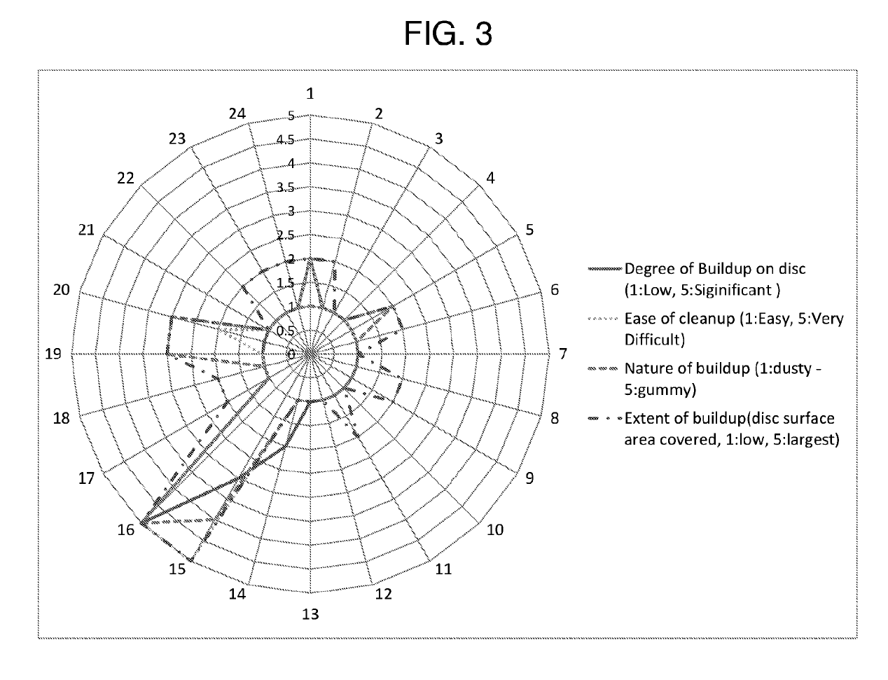

The treatments were provided at 5, 10, and 20 g/unit and was divided as follows: Present Invention Trial A (Treatments 2-4) (82.5% w/w Talc, 17.5% w/w Silicon Oil(AK350)), Present Invention Trial B (Treatments 5-7) (80.75% w/w Talc, 17.5% w/w Silicon Oil (AK350), 1.75% w/w emulsifier), Present Invention Trial C (Treatments 8-10) (82.5% w/w Talc, 17.5% w/w Silicon Oil(AK12500)), and Present Invention Trial D (Treatments 11-13) (80.75% w/w Talc, 17.5% w/w Silicon Oil (AK12500), 1.75% w/w emulsifier), along with Fluency Agent from Bayer Crop Science (Treatments 14-16), Talc (Treatments 17-20) and Graphite (Treatments 21-24). The Talc and Graphite treatments were also provided at their standard recommended rates. Talc: 70 g/unit (Treatment 20) and Graphite: 14.5 g/unit (Treatment 24). A control with no flow aid was also included in the study and is labeled as Treatment 1. All treatments were evaluated for dust-off (FIG. 1), seed-flowability (FIG. 2) and an evaluation of the planter plates for material build-up (FIG. 3).

The dust-off was calculated with the Heubach Dust-Off test, a standard industry method. It utilized a 200 gram scale test method, with a test time of 5 minutes, and an airflow of 20 L/min. The value provided is an average out of two replicates where the acceptable dust limit is 0.75 g dust/100,000 seeds.

The dry flowability test was done within a standard industry method. The values are provided as a % regarding to the standard samples.

1. A composition to improve the flowability and plantability of pesticide treated seeds comprising:
a. A solid carrier; and
b. An oil component.

2. The composition according to claim 1, wherein the solid carrier is talc, graphite or mixtures thereof.

3. The composition according to claim 1, wherein the solid carrier is talc.

4. The composition according to claim 1, wherein the oil component is silicone oil.

5. The composition according to claim 1, wherein the oil component is polydimethylsiloxane oil.

6. The composition according to claim 1, wherein the composition further comprises a surface active compound.

7. The composition according to claim 1, wherein the composition does not include a polymer.

8. A composition to improve the flowability and plantability of pesticide treated seeds consisting essentially of:
a. A solid carrier;
b. An oil component, and
c. A surface active compound.

9. A composition to improve the flowability and plantability of pesticide treated seeds consisting of:
a. A solid carrier;
b. An oil component, and
c. A surface active compound.
